(19) United States
(12) Patent Application Publication
(10) Pub. No.: US 2013/0332322 A1
(43) Pub. Date: Dec. 12, 2013

(54) DISCARD CART

(71) Applicants: Dion B. Perkins, Cincinnati, OH (US); Nikki R. Ferneding, Harrison, OH (US); Brian Listermann, West Chester, OH (US); Michelle Boardman, Independence, KY (US)

(72) Inventors: Dion B. Perkins, Cincinnati, OH (US); Nikki R. Ferneding, Harrison, OH (US); Brian Listermann, West Chester, OH (US); Michelle Boardman, Independence, KY (US)

(73) Assignee: SUNRISE R&D HOLDINGS, LLC, Cincinnati, OH (US)

(21) Appl. No.: 13/490,174

(22) Filed: Jun. 6, 2012

(51) Int. Cl. G06Q 10/08; B62B 3/10

(52) U.S. Cl. 705/28; 280/47.34; 280/47.35

(57) ABSTRACT

A method of managing discard items in a retail environment includes using a mobile device, positionable proximate a region of the retail environment in which the discard items are present, to scan machine readable item identifying information from an item to be discarded, determining, based on the identifying information, whether the item is priced per unit weight or per item, wherein for items priced per item, a number of items is requested from a user and for items priced per unit weight, performing a weighing of the item, wherein the weighing comprises weighing the item using a scale mounted on a cart in the region of the retail environment, and transmitting, to a store network the item identifying information and the number of items or weight of the item.

### FIELD

Embodiments herein generally relate to inventory control and more particularly to a device for use in management of discard items in a retail environment.

### BACKGROUND

In a retail operation systems for collecting stock for returns/discard may be useful. Particularly where perishable goods are sold, such as in a grocery, it may be necessary from time to time to remove stock from the sales floor and dispose of it. Typically, a sales associate will use an ordinary shopping cart or a wheeled bin to collect discard items, then bring them to a stock area for inventory and disposal.

For various reasons, it may be useful to track materials disposed of in this way. For example, where automated ordering systems are used, tracking sales without tracking discards will tend to result in overcounting an expected amount of an item in stock. Likewise, it may be useful to identify particular products that account for disproportionate discards and change policies or procedures with respect to those products.

### SUMMARY

According to one aspect of the present embodiments, there is provided a method managing discard items in a retail environment includes using a mobile device, positionable proximate a region of the retail environment in which the discard items are present, to scan machine readable item identifying information from an item to be discarded, determining, based on the identifying information, whether the item is priced per unit weight or per item, wherein for items priced per item, a number of items is requested from a user and for items priced per unit weight, performing a weighing of the item, wherein the weighing comprises weighing the item using a scale mounted on a cart in the region of the retail environment, and transmitting, to a store network the item identifying information and the number of items or weight of the item.

According to another aspect of an embodiment, a system for collecting discard items includes a cart, comprising, wheels, a product storage portion, supported by the wheels and comprising at least one shelf, a handle, configured and arranged to allow a user to move the cart, a discard item storage container, a scale, operatively associated with the discard item storage container, the scale being configured and arranged to weigh items placed in the discard item storage container, and a mobile device, configured and arranged to communicate with the scale to receive weights of items weighed thereby.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features will become better understood with regard to the following description, pending claims and accompanying drawings, in which like reference numerals identify like elements and in which:

FIG. 1 is a schematic illustration of a discard cart in accordance with an embodiment of the invention.

### DETAILED DESCRIPTION

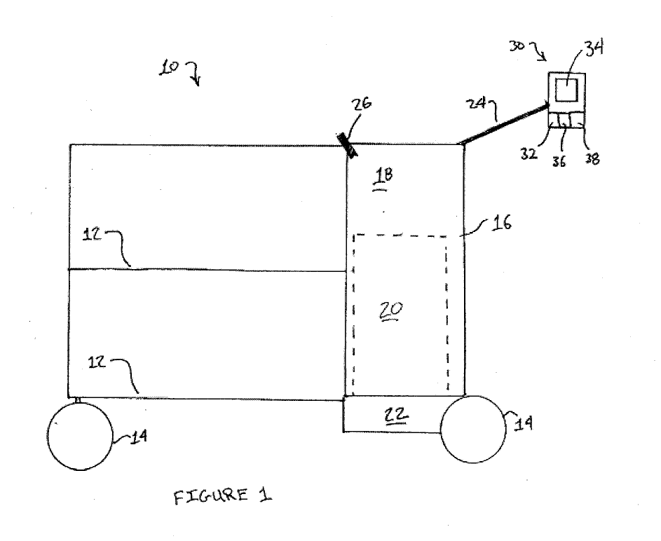

In an embodiment as shown in FIG. 1, a discard cart 10 has a product storing portion that includes one or more shelves 12 for holding items to be accounted for and discarded. The shelves may be bare, or may incorporate partitions for separating items of different types, not shown. The cart 10 includes wheels 14 which may further include a loss prevention module such as a wheel brake that engages automatically if the cart is removed from a predetermined area (e.g., the store and its local environs including the parking lot and/or loading dock).

In the illustrated embodiment, a compartment 16 may include a hinged door 18 allowing access to the compartment while also providing the possibility of concealment of items which may not appeal to shoppers such as spoiled produce. The compartment may include a waste basket and/or disposable container 20 for discarded items.

In an embodiment, the container 20 is operably associated with a scale 22. For example, the container may be directly supported by the scale, or there may be an intermediate support structure that supports the container and that is itself supported and therefore measureable by the scale. The scale 22 may be a digital or analog scale, and may include a machine readable output such that readings of the scale may be made available for further processing by an inventory system as discussed further below and may further include a user readable output if necessary or desired. Embodiments may include a user operated or automated tare function so that as new items are placed in the container and weighed by the scale, weights of previously placed items and/or the container itself are excluded from the measured weight value. In an embodiment, the cart includes a display (not shown) that can provide user readable information.

The cart further includes a handle 24 by way of which it may be pushed by an operator. One or more hooks 26 may be attached to the handle or to another portion of the cart such as one of the shelf edges. As will be appreciated, the hooks may allow for bagged items to be supported or for a supply of bags for use in discard operations to be positioned for access by the operator.

In an embodiment, the cart is equipped with or associated with a mobile device 30 that incorporates a reader 32, a display 34, a memory 36 and a user interface 38. The mobile device 30 may be detachably or permanently connected to the cart, or may be borne by the cart operator, for example on a belt clip or the like. The mobile device 30 and its user interface may operate as the display of the cart 10 mentioned above with respect to the scale, or may alternately communicate with a separate display of the cart to provide an alternate viewing area for the user.

Embodiments include wireless communication functionality so that the mobile device 30 may communicate with a store network. The mobile device 30 may communicate using one or more of a number of common protocols including but not limited to BLUETOOTH (IEEE 802.15.1 and 802.15.2), WIMEDIA (IEEE 802.15.3), WI-FI (IEEE 802.11b), Wi-Fi5 (IEEE 802.11a/HL2) and other wireless protocols like protocol 802.15.4 (ZIGBEE). The store network may include functionalities for associate task management, shopper self-checkout, video or location based analytics, price lookup, loss management, and others.

In some embodiments, the store network may include one or more of a star network, a multi-network, mesh network, and wireless and/or wired communication lines joining each of the several nodes to a server. In some embodiments, each node may include one or more radios or wired links to communicate with others of the nodes and/or the server. Examples of store networks that may be suited to incorporation with embodiments may be found in U.S. Pat. No. 7,672,876, herein incorporated by reference.

The mobile device 30 may also include wireless and/or wired communications with the cart electronics (e.g., the scale 22), either directly or via the store network.

In a method of use, a sales associate will turn on and optionally log in to the mobile device 30 by providing, for example, a user-specific code such as an employee ID or other identifying information. Where the scale 22 or other electronic components of the cart are to be used, they may then be powered on, though the order between cart power on and mobile device log in may be varied as useful or required.

In an embodiment, the mobile device 30 may be used to scan identifying information on the cart, for example a bar code. As will be appreciated, other machine readable identifying codes may be used in place of bar codes. Machine readable media in certain embodiments may also able to be read and understood by humans in addition to being able to be read by machines. Examples of a machine readable medium include, but should not be limited to, bar codes in the form of Universal Product Codes (UPC), Radio Frequency Identification (RFID) tags, produce lookup codes (PLU), including double stack PLUs, and Electronic Product Codes (EPC) tags.

Where a removable container, waste bag or liner is to be used, the associate will be prompted by a display, either associated with the mobile device or directly associated with the cart, to load the bag, liner or removable container. Once the waste containing components are fully loaded, the scale can be tared or zeroed either automatically or in response to a user input.

Once setup is complete, an operator will wheel the cart through a store or a portion of the store searching for discard items. As will be appreciated, items to be discarded may include produce that has an unpleasant appearance, is damaged, or is otherwise unlikely to be sold to a customer or packaged items that are damaged, opened or past a sell-by date, for example.

In an embodiment, management messages may be sent to the mobile device 30 or to a display portion of the cart 20 instructing the associate to address a particular area of the store, i.e., a specific section (canned vegetables, aisle 2, fruits) or even a specific item (bananas, ground beef). Such messages may be generated, for example, in response to customer complaints, a timed or calendared schedule, or other triggering event.

As items are removed from the sales floor, they may be scanned using the reader 32, or an item code may be entered into the mobile device 30. As will be appreciated, an item lookup function may be included to allow for determining item identifying information where that information is not uniquely resolvable by the scan, for example where codes are damaged, partially obscured or subject to other difficult conditions (e.g., non-flat packaging or, in the case of PLUs, produce having a curved surface). In this regard, for items with partial bar codes or other partial identifying information, functionality may be included, in the mobile device or in a separate element of the store network, for item discrimination. Examples of methods of evaluating partial identifying information that are compatible with embodiments are described in U.S. pat. application Ser. No. 13/037,532 filed Mar. 1, 2011, published as U.S. Patent Application Publication No. 2011/0286344 on Nov. 24, 2011, herein incorporated by reference. By way of further example, where a partial read corresponds to a limited list of products, the user may be provided with a menu from which to select. In embodiments in which the mobile device 30 includes functionality for determining its location within the store, a query to the store network may allow for narrowing the list of possible products based on store location. For example, where an unresolved read has the possibilities of cheddar cheese or macaroni and cheese dinner manufactured by a common manufacturer, the fact that the read is taking place in the dairy aisle may allow for complete resolution when the partial read is combined with location information.

For items sold on a per item basis, the operator may separately scan each item, or alternately enter the number of items directly via the user interface 38. For items sold by weight, the items are placed in the container 20 such that they may be weighed by the scale 22. In an embodiment, the weight information is automatically associated with the item identifying information.

As will be appreciated, embodiments may include functionality for using weight information as a check on the item identifying information. This approach may have limitations in that damaged goods are more likely to be outside the specified weight range. Therefore, it may be useful to include a user override that allows the sales associate to confirm that the item is correct in response to a weight/item identifier disagreement identified by the system.

In an embodiment, a single identifying scan may be performed for a plurality of items, and each corresponding item placed in the container 20 until all like items have been collected. Subsequently, a representative of the next item type is scanned to begin the process for that item type.

As items are identified and weighed, the information may be transmitted in real time to the store network, or alternately may be stored locally and transmitted on a batch basis, either when an item type, a section, or an assigned task is complete. In embodiments, the user may optionally have an opportunity to accept or correct item identifying information as it is read, in response to a prompt at the user interface 38.

In some embodiments of the method, after removing discard items, the sales associate replaces removed items with fresh items held on the shelves 12 of the cart. As will be appreciated, the use of container 20 for disposal in a region of the cart separated from the shelves 12 allows for separation between fresh and disposal items which may be more aesthetically pleasing to customers in the store during discard operations.

In addition to discard, the cart may be employed in a reshopping operation (i.e., collecting misplaced items from the sales floor and returning them to their proper locations within the store). In this regard, certain shelves or portions of shelves of the cart may be allocated to reshoppable items while other shelves or portions thereof may be allocated to discard items.

In an embodiment, the scale and other electronics associated with the cart may be powered by a rechargeable battery. When the cart is not in use, it may be connected to a power supply to allow for recharging of the battery via a power connector. In one approach, recharging circuitry may be included in the cart system itself. In an alternate approach, the recharging circuitry may be separate from the cart, and thus a single recharger may be used for multiple carts in turn.

In an embodiment, as a discard transaction is completed and the data is transferred to the server, location information gleaned from communication between the mobile unit 30 and the network is included.

The specifics of how the network is able to identify a location of a mobile device are disclosed, for example, in U.S. application Ser. No. 12/172,326 filed on Jul. 14, 2008 and issued as U.S. Pat. No. 7,672,876 on Mar. 2, 2010, U.S. application Ser. No. 12/408,581 filed on Mar. 20, 2009 and issued as U.S. Pat. No. 7,742,952 on Jun. 22, 2010, U.S. application Ser. No. 12/353,817 filed on Jan. 14, 2009 and issued as U.S. Pat. No. 7,734,513 on Jun. 8, 2010, and U.S. application Ser. No. 12/353,760 filed on Jan. 14, 2009 and issued as U.S. Pat. No. 7,739,157 on Jun. 15, 2010, the relevant disclosures of each of which are fully incorporated by reference.

Location information for a discard task may be used in store management functions. For example, the use of location information may allow for identification of particular shopper behavior that leads to discard. For example, if the store finds that it is discarding a large amount of organic produce found in portions of the store containing traditionally grown produce, it may be deduced that shoppers are substituting traditional choices for an initial organic choice. To the extent that this results from store layout (e.g., organic bananas may be located near an entrance, initially attracting a shopper who eventually replaces them with lower-cost ordinary bananas found later in the trip through the store), layout changes may be made. Alternately, improved signage may allow for better customer information, preventing the initial incorrect choice.

While in the foregoing specification this invention has been described in relation to certain particular embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A method of managing discard items in a retail environment comprising:
using a mobile device, positionable proximate a region of the retail environment in which the discard items are present, to scan machine readable item identifying information from an item to be discarded;
determining, based on the identifying information, whether the item is priced per unit weight or per item, wherein for items priced per item, a number of items is requested from a user and for items priced per unit weight, performing a weighing of the item;
wherein the weighing comprises weighing the item using a scale mounted on a cart in the region of the retail environment; and
transmitting, to a store network the item identifying information and the number of items or weight of the item.

2. A method as in claim 1, wherein the number of items is requested via a user interface of the mobile device and wherein a result of the weighing is transmitted from the scale to the mobile device, and the transmitting to a store network is performed by the mobile device.

3. A method as in claim 1, wherein, prior to scanning a first item to be identified, the user provides user identifying information to the mobile device.

4. A method as in claim 1, wherein, prior to scanning a first item to be identified, the mobile device is used to scan a cart identifying code associated with the cart.

5. A method as in claim 1, wherein the store network comprises a database and the database stores entries corresponding to each identified item including information relating to a number of items or a weight of the item.

6. A method as in claim 1, further comprising:
using store location information in conjunction with the machine readable item identifying information to confirm an item identification.

7. A system for collecting discard items comprising:
a cart, comprising:
wheels;
a product storage portion, supported by the wheels and comprising at least one shelf;
a handle, configured and arranged to allow a user to move the cart;
a discard item storage container;
a scale, operatively associated with the discard item storage container, the scale being configured and arranged to weigh items placed in the discard item storage container; and
a mobile device, configured and arranged to communicate with the scale to receive weights of items weighed thereby.

8. A system as in claim 7, wherein the mobile device further comprises a reader configured and arranged to read item identifying information from the discard items.

9. A system as in claim 8, wherein the mobile device is further configured and arranged to communicate with a store network to provide to the store network the identifying information and weights of items weighed by the scale.

10. A system as in claim 7, wherein the cart further comprises cart identifying machine readable indicia readable by the mobile device.

11. A system as in claim 7, wherein the cart further comprises a cart power supply, configured and arranged to provide power to the scale; and
a power connector, connectable to an external power supply to recharge the cart power supply.

12. A system as in claim 7, wherein the discard item storage container further comprises a door, openable to provide access to the discard item storage container and closable to conceal items in the discard item storage container.

13. A system as in claim 7, wherein the cart further comprises at least one hook configured and arranged to hold a supply of bags.

14. A system as in claim 7, wherein the product storage portion is partitioned such that fresh product may be stored separately from discard items in the product storage portion.

15. A system as in claim 7, wherein the scale is operable to re-set a tare weight after each item is placed in the discard item storage container.
